(19) United States
(12) Patent Application Publication
(10) Pub. No.: US 2009/0201498 A1
(43) Pub. Date: Aug. 13, 2009

(54) Agile Spectrum Imaging Apparatus and Method

(76) Inventors: Ramesh Raskar, Cambridge, MA (US); Ankit Mohan, Evanston, IL (US); Jack Tumblin, Evanston, IL (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/028,944

(22) Filed: Feb. 11, 2008

(51) Int. Cl. G01J 3/04

(52) U.S. Cl. 356/310

(57) ABSTRACT

An optical system performs agile spectrum imaging. The system includes a first lens for focusing light from a light source. The focused light is dispersed over a spectrum of wavelengths. A second lens focuses the dispersed light onto a mask. The mask selectively attenuates the wavelengths of the spectrum of the light source onto an image plane of the light destination. Depending on the arrangement of the light source and destination, the system can act as a 2. The apparatus of claim 1, in which the light source is a scene and the light destination is sensor, and the apparatus operates as an agile spectrum camera, viewer, spectrum projector, or light source. The arrangement can also be combined to provide a stereo vision system.

### FIELD OF THE INVENTION

This invention relates generally to imaging, and more specifically to spectrum selective imagining.

### BACKGROUND OF THE INVENTION

Most conventional imaging devices, e.g., cameras, projectors, printers, televisions and other display devices, rely on the well-established trichromatic response of human vision. Any modest variation in the sensations of color caused by spectral variations in a scene can be recreated without the need to adjust the spectrum of the imaging device.

Fixed spectrum imaging discards or limits our ability to detect or depict subtle but visually useful spectral differences. In the common phenomena of metamerism, the spectrum of available lighting used to view, photograph or render objects can cause materials with notably different reflectance spectra appear to have the same color, because they match the same amounts of the fixed color primaries in our eyes, the camera or the display.

The use of fixed-spectrum color primaries always impose limits on the gamut of colors we can acquire and reproduce accurately. As demonstrated in the CIE chromaticity map 601 of normal human vision, each set of fixed color primaries in cameras, printers and displays defines a hull 602, and only the colors inside the hull are accurately reproducible, see FIG. 6.

Many photographic light sources mimic the smooth spectral curves of black-body-radiators, from 3200 K (tungsten) to 6500K (daylight) standards established for film emulsions. In digital cameras, a Bayer grid of fixed, passive RGB filters is overlaid on the pixel detectors or sensors to fix the color primaries. A similar passive pixel-by-pixel filter combines with a fluorescent backlight fix the color primaries in LCD displays.

While the color primaries for some recent small projectors are fixed by emissive spectra of narrow-band LEDs or solid state lasers, most DMD or LCD projectors use more conventional broad-band light sources passed through a spinning wheel that holds passive RGB filter segments. These filters must compromise between narrow spectra that provide a wide gamut, and broad spectra that provide greatest on-screen brightness.

However, if the spectra of each color primary was “agile,” that is, changeable and computer specified for every picture, then one could select the best primaries on an image-by-image basis, for the best capture and rendering of visual appearance.

Computer-controlled adjustments of spectra is difficult. Conventional spectral adjustment mechanisms include tunable lasers, LCD interference filters, and motorized diffraction gratings. They trade off size, expense, efficiency and flexibility. Despite these difficulties, specialized ‘multispectral’ or ‘hyperspectral’ cameras and light sources lights partition light intensities or reflectances into many spectrally narrow bands.

The idea of dispersing light using spectroscopy to modulate various light components is certainly not new. However, spectroscopy mainly deals with the analysis of the spectrum of a point sample. The concept of imaging spectroscopy or multi-spectral photography is relatively new.

Liquid crystal tunable filters (LCTF), acousto-optical tunable filter (AOTF), and interferometers are now available for imaging spectroscopy. Placing one of these filters in front of a camera allows a controllable wavelength of light to pass through. By acquiring a series of images, one can generate a multi-spectral image.

Unfortunately these filters are rather expensive, and usually only allow a single wavelength of light to pass through using a notch pass. For example, an imaging spectroscope disperses light rays into constituent wavelengths. The wavelength can then be combined using another diffraction grating.

The concept of a spectroscope to generate a spectrally tunable light source using a diffraction grating and a white light source is known. This has been extended to generate a fully controllable spectrum projector. Several narrow band LEDs can be used to illuminate an object and acquire multi-spectral images. This is similar to having more than three LEDs in projectors to get better color rendition.

A tunable light source can also be used in a DLP projector. By controlling the wavelength emitted by the source, together with the spatial modulation provided by the DLP projector one can select the displayed colors.

A diffraction grating can be used to disperse light into its wavelengths, modulate it differently for each pixel in a scanline, and then project a single scanline at a time using a scanning mirror arrangement to form the image.

Color is important part in the art of graphics. Arbitrary ink pigments can be used to reproduce the right color in a printout. A Bidirectional Reflectance Distribution Function (BRDF) model can be used for diffuse fluorescent surfaces. Images can also be printed with fluorescent inks that are visible only under ultraviolet illumination.

It is desired to provide a method and apparatus for color modulation in the areas of metamer detection, glare removal, high dynamic range imaging, which have not been described up to now.

### SUMMARY OF THE INVENTION

The embodiments of the invention provide a method and apparatus to dynamically adjust the color spectra in light sources, camera and projectors. The invention provides an optical system that enables mechanical or electronic color spectrum control. The invention uses a diffraction grating or prism to disperse light rays into various colors, i.e., a spectrum of wavelengths. A mask placed in dispersed light to selectively attenuate the wavelengths of the spectrum.

The agile spectrum apparatus and method can be used in a camera, projector and light source for applications such as adaptive color primaries, metamer detection, scene contrast enhancement, photographing fluorescent objects, spectral high dynamic range photography.

### BRIEF DESCRIPTION OF THE DRAWINGS

FIG. 1A is a schematic of a spectrum agile imaging apparatus according to an embodiment of the invention;

FIG. 1B is a schematic of an agile spectrum camera according to an embodiment of the invention;

FIG. 1C is a schematic of an agile spectrum viewer according to an embodiment of the invention;

FIG. 1D is a schematic of an agile spectrum projector according to an embodiment of the invention;

FIG. 1E is a schematic of an agile spectrum light source according to an embodiment of the invention;

FIG. 1F is a schematic of an agile spectrum stereo vision system according to an embodiment of the invention;

FIG. 1G is a schematic of a spectrum agile imaging method according to an embodiment of the invention;

FIG. 2 is a schematic of optics of the apparatus of FIG. 1A with a pinhole objective lens;

FIG. 4 is a schematic of optics of the apparatus of FIG. 1A with a bent optical axis;

FIG. 4 is a schematic of optics of the apparatus of FIG. 1A with a finite aperture objective lens;

FIG. 5 is a graph of wavelength as a function of pixel position; and

FIG. 6 is a conventional color gamut.

### DETAILED DESCRIPTION OF THE PREFERRED EMBODIMENTS

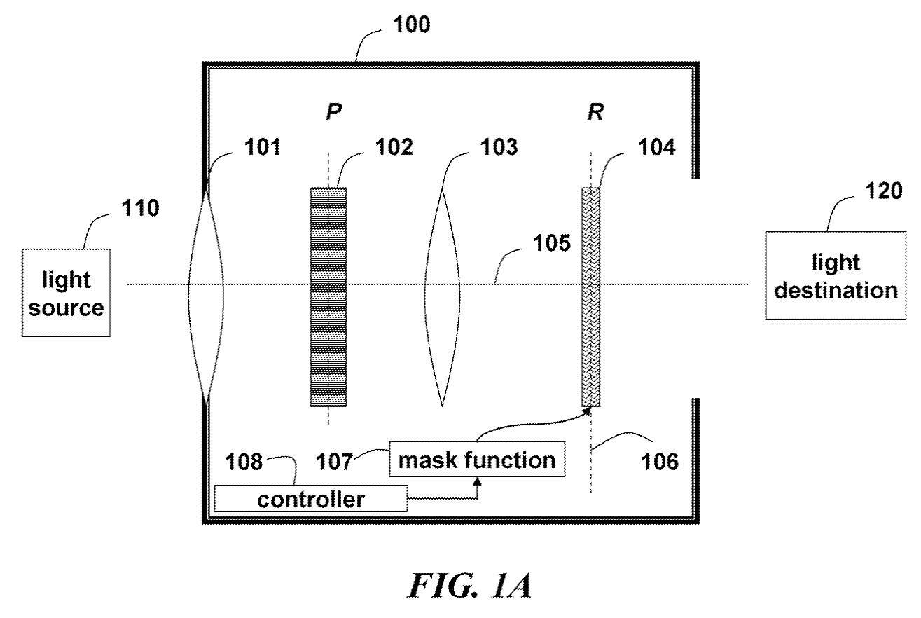

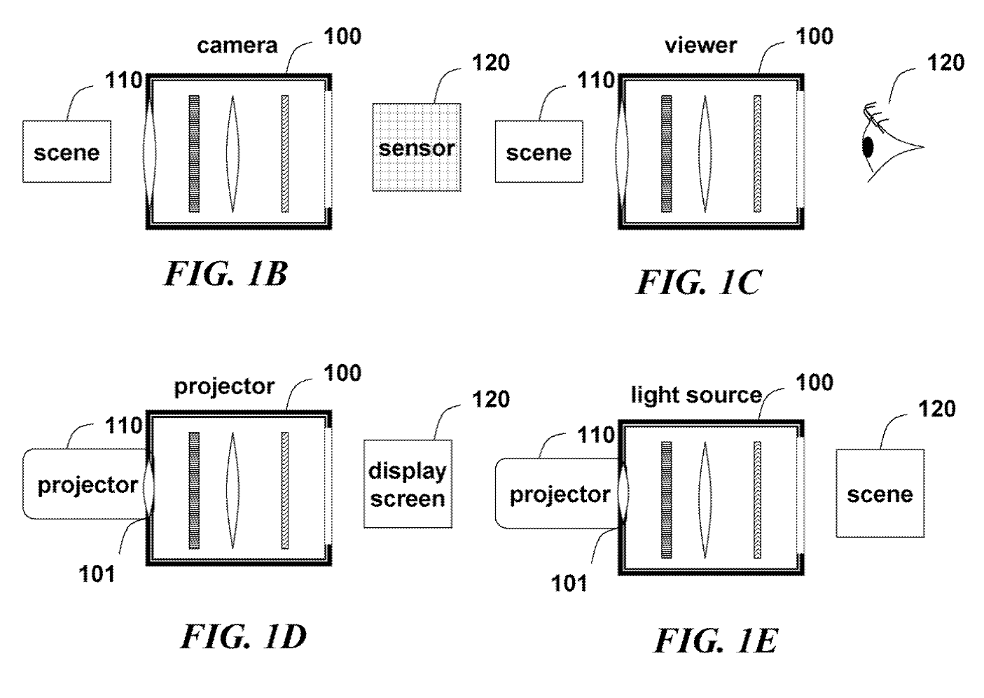

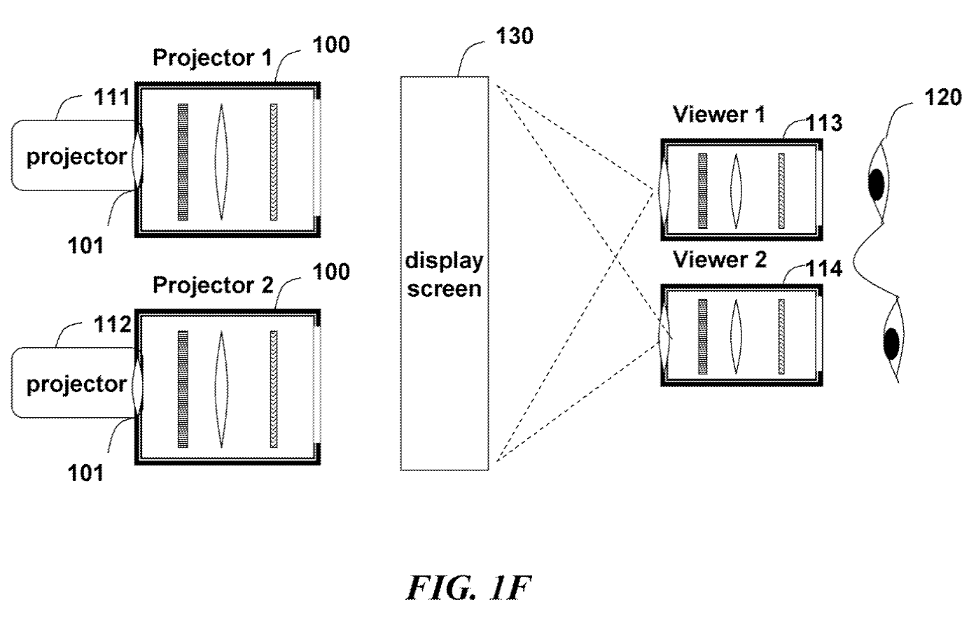

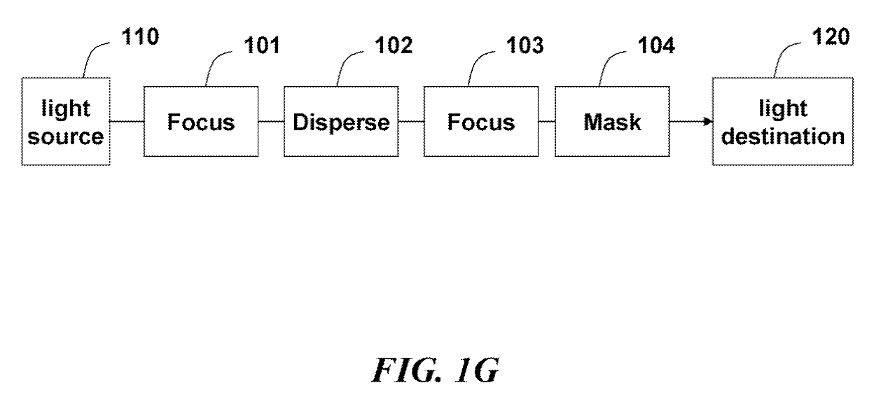

FIG. 1A an agile spectrum imaging apparatus 100 according to an embodiment of our invention. The apparatus including a first lens L₁ 101, means for dispersing 102, a second lens L₂, and a mask 103, all arranged in an order on an optical axis 105 between a light source 110 and a light destination 120. The mask selectively attenuates wavelength of a spectrum of the light source onto an image plane of the light destination. One way to select is to use a controller 108 and mask function 107.

FIGS. 1B-1E show various applications how the apparatus 100 of FIG. 1A can be used. In FIG. 1B, the light source 110 is a scene and the light destination 120 is a CCD or film sensor, and the apparatus operates as an agile spectrum camera. In FIG. 1C, the light source is a scene and the light destination is an eye, and the apparatus operates as an agile spectrum viewer or camera view finder. In FIG. 1D, the light source is a projector and the light destination is a display screen, and the apparatus operates as an agile spectrum projector. In FIG. 1E, the light source is a projector, and the light destination is a scene, and the apparatus operates as a agile spectrum light source.

Stereo Vision System

FIG. 1F shows have two projector and viewers as described above can be combined to form a stereo vision system. In one application, we combined the operation of our agile spectrum projector and our agile spectrum direct view device or camera. For example, we perform wavelength multiplexing, as opposed to time multiplexing, to generate a stereo display.

The two projectors 111-112 have complementary non-overlapping spectrum profiles, such that each has a band in the spectral wavelengths matching the red, green and blue hues of the human visual system. Each projector is paired with corresponding direct view devices 113-114 (one for each eye of the observer) that has the same spectrum profile. This gives us direct control over the full-color image viewed by each eye. Unlike a time-multiplexed stereo arrangement, wavelength multiplexing works for high speed cameras as well. The projectors can project images onto a display screen 130 so that multiple users 120 can view the images.

Wavelength multiplexing is better because it is transparent to a RGB camera, unlike time multiplexing, which introduces artifacts in high speed cameras. Such as paired arrangement is also useful to obtain the complete Bidirectional Reflectance Distribution Function (BRDF) of fluorescent materials, as described in greater detail below.

FIG. 1 G shows a method for agile spectrum imaging. Light from a light source is focused 101 on means for dispersing. The focused light is then dispersed 102 and focused 103 onto a color selective mask. The focused dispersed light is then masked 104 for a light destination 120.

In one embodiment, the first lens L₁ can have a focal length of 80 mm. The means for dispersing can be a blazed transmissive or reflective diffraction grating with 600 grooves per mm. Alternatively, a prism can be used. The second lens L₂ has a focal length 50 mm.

The mask can be moved in a plane tangential to the optical axis by a stepper motor. The mask can be a grayscale mask to selectively block, modulate or otherwise attenuate different wavelengths according to a mask function 107. The mask is printed on transparencies using, driven back and forth using a stepper motor. Alternatively, that the mask can also be in to form of a LCD or DMD as described in greater detail below. It should be noted, that the lenses, mask can be according to other parameters depending on the application.

The arrangement of the optical elements 101-104 generates a plane R 106 at the mask 104 where all the rays of the light source for a particular wavelength meet at a point. Thus, we obtain a one-to-one mapping between the wavelength of the ray and a spatial position in the plane. As shown in FIG. 1A, the mask 104 coincides with the plane 120. The rays are then re-focused by the second lens to the light destination 120 with the spectrum of all points in the image modulated according to a mask function.

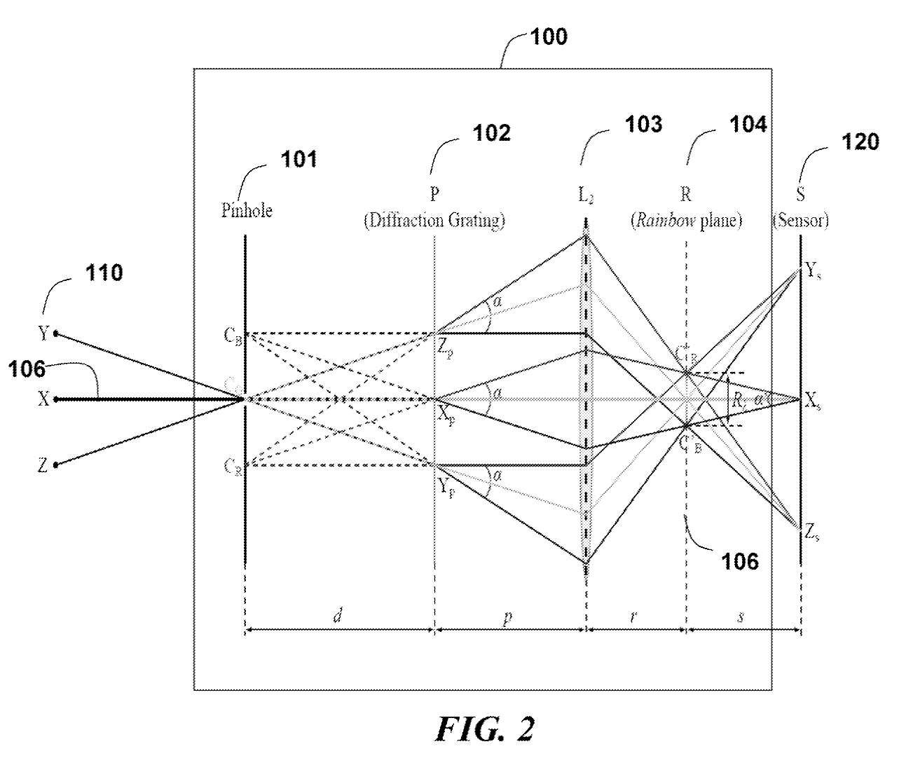

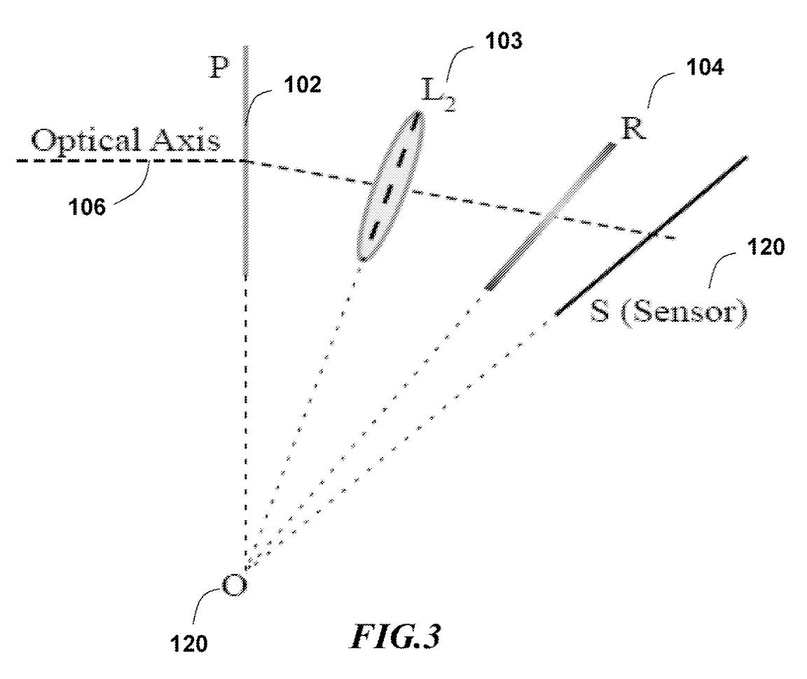

FIG. 2 shows a simplified ray diagram for our optical apparatus 100 with a pinhole in place of the objective first lens L₁ 101 The pinhole images the scene onto the plane P at the means for dispersing 102. Rays from points X and Y in the scene 110 are imaged to points Xₚ and Yₚ respectively. Therefore, we place the diffraction grating 102 or a prism in the plane P.

The means for dispersing works on the wave nature of light. A ray incident on the diffraction grating effectively produces multiple dispersed outgoing rays in different directions, as shown, given by a grating equation:

$${φ}_{m} = {sin}^{- 1} ( \frac{m λ}{d} - sin ( {φ}_{i} ) ,$$

where d is the grating constant, i.e. the distance between consecutive grooves, φₘ is the incident ray angle, φᵢ is the output ray angle for integer order m, and λ is the wavelength of the ray of light.

Order 0 corresponds to the dispersed ray going through the diffraction grating undeviated by direct transmission. As can be seen from the grating equation, the dispersion angle is a function of the wavelength for all orders other than order 0. This causes spectral dispersion of the incident light ray. Because higher orders have increasingly lower energy, we use order 1 in our arrangement.

As shown in FIG. 2, all optics after the plane P are applied to order 1. Note that while order 1 is actually “bent” with respect to the incident rays, we show the green component (λ=550 nm) going straight through the diffraction grating. The red component (λ=700 nm) and the blue component (λ=400 nm) are dispersed in opposite directions. This is done to simplify the figure.

Because we work with a first order of the dispersion, the optical axis 105 is effectively “bent” as shown in FIG. 3. We compensate for this by placing the second lens, mask, and the sensor or screen at an angle with respect to the diffraction grating, or origin O 301 instead of parallel to the grating.

The lens L² focuses the light after the plane P onto the sensor or screen plane S. In other words, plane S is the conjugate to plane P. All the spectrally dispersed rays coming out of point Xₚ on the diffraction grating converge at Xₛ on plane S. Thus, the image on the sensor, eye or screen (generally light destination) is exactly the same as the image formed on the dispersion plane through the pinhole, without any chromatic artifacts.

We ensure that the second lens L₂ does not produce any vignetting. Traditional vignetting artifacts usually results in the dark image corners, which that can be calibrated and fixed to some extent in post-processing. However, vignetting leads to serious loss of information in our case as some spectral components of corner image points might not reach the sensor or screen at all. Visually, vignetting results in undesirable visible chromatic artifacts at the plane S.

Tracing back the dispersed color rays to the plane of the pinhole lens in FIG. 2, we see that all the red rays appear to come from a point C_{R}; all green rays from a point C_{B}, and so on. The second lens L₂ serves a second purpose. It focuses the plane of the pinhole to the R-plane The R-plane is conjugate to the plane of the pinhole across the second lens L₂.

If we were to place a screen in this plane we would see a thin line with colors ranging from red to blue like a rainbow. Thus, the name R- or rainbow-plane. All the dispersed rays of a particular wavelength from all the points in the scene arrive at the same point on the R-plane. This is useful because by putting a mask corresponding to a certain wavelength in this plane, we can completely remove that color from the entire image being formed at the plane S. By placing an arbitrary mask or an LCD in this plane, we can simulate internally to the apparatus any arbitrary color filter that would otherwise be placed in front of a camera or a projector.

To make the analysis easier, we assume all rays are paraxial, which means all rays make small angles to the optical axis 106, and remain close to it.

Tracing the rays from point X, we have

$${α}^{′} = \frac{{R}_{λ}}{s} ,$$

where s is the distance between the R-plane and S plane, and a′ is an angle of a cone made by rays converging on the plane S at points Xₛ.

We also have

pα(r+s)α′,

where p is the distance between the diffraction grating and the second lens L₂, and a is the dispersion angle of the grating, see FIG. 2. This gives us,

$${R}_{λ} = \frac{sp}{r + s} α .$$

From the lens equations we have,

$$\frac{1}{p} + \frac{1}{s + r} = \frac{1}{{f}_{2}} , \\ and$$

$$\frac{1}{p + d} + \frac{1}{r} = \frac{1}{{f}_{2}} .$$

Rearranging terms, we obtain

$$\begin{matrix}r = \frac{{f}_{2} ( p + d )}{p + d - {f}_{2}} , & ( 1 ) \\ s = \frac{{df}_{2}^{2}}{( p - {f}_{2} ) ( p + d - {f}_{2} )} , & ( 2 ) \\ {R}_{λ} = α \frac{{df}_{2}}{p + d - {f}_{2}} . & ( 3 )\end{matrix}$$

Above, we assumes a pinhole is used to focus the light source 110) on the means for dispersing 102. While this is easy to understand and analyze, it only lets through a very small amount of light, and is not very practical.

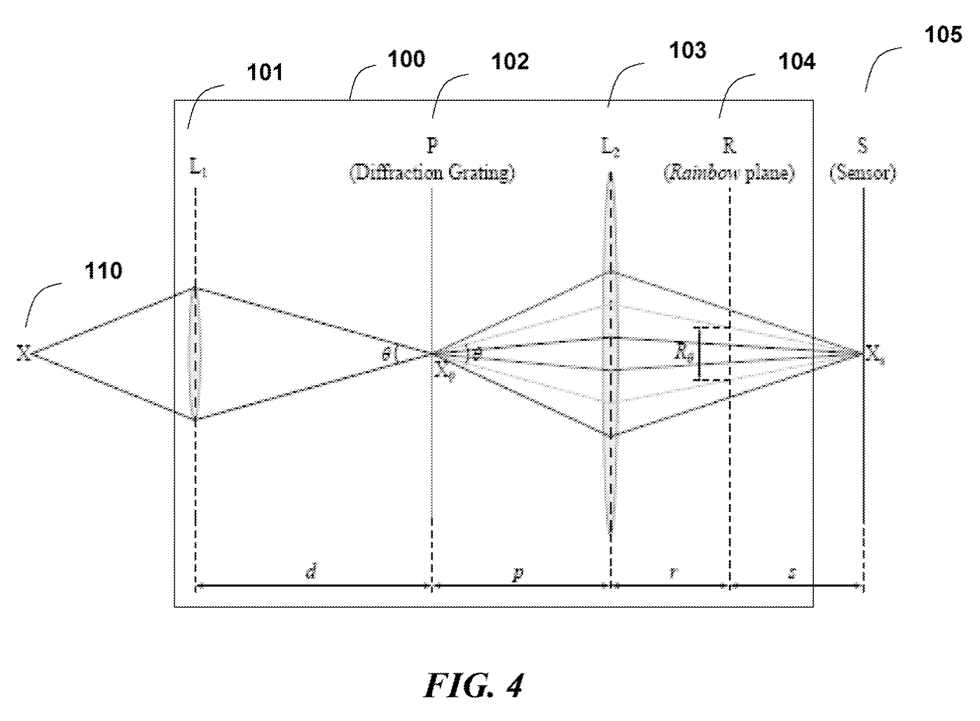

FIG. 4 shows the optical arrangement of our apparatus 100 with a finite sized first lens L₁ 101, instead of the pinhole. The lens L₁ exactly focuses the scene point X on the dispersion plane P. For each in-focus scene point, we have a cone, with cone-angle q, of incoming rays at the image on the grating Xₚ.

The diffraction grating disperses each of these rays into its constituent wavelengths. For each ray in the incoming cone of rays for each scene point, we obtain a cone of outgoing rays, each of a different color. Like the pinhole case, the dispersion angle is a.

Because the plane S is conjugate to the diffraction grating plane P, the scene point is imaged at the location Xₛ at the plane S. Not only is the point in sharp focus, it is also the correct color, and there is no chromatic blur.

However, the R-plane is different than for the case of the pinhole lens. Instead of producing a line where each point corresponds to a wavelength in the scene, each wavelength of each scene-point is blurred to a size R_{q}.

Following the same reasoning as Equation 3, we obtain

$${R}_{θ} = θ \frac{{df}_{2}}{p + d - {f}_{2}} . \qquad ( 4 )$$

The cone-angle θ is

$$θ = \frac{{α}_{1}}{d} ,$$

where a₁ is the aperture of the first lens L₁.

From Equations 3 and 4, we obtain

$$\frac{{R}_{θ}}{{R}_{λ}} = \frac{θ}{α} = \frac{{a}_{1}}{d} .$$

In the pinhole case, we had R_{θ}=0. In the finite aperture case, we would like to have R₇₄ <<Rₐ. If the dispersion angle a is fixed, which depends on the diffraction grating used, we require that

a. a₁<<d. (5)

This is achieved by using a lens with a relatively large focal length, e.g., 80 mm, and small aperture. It should be noted, that the focal length and aperture are due to the unique arrangement of our optical elements, and cannot be determined from prior art cameras and projectors, which do not have the arrangements as shown. A large aperture allows more light but effectively reduces the spectral selectivity of our system by increasing the R_{θ} blur in the R-plane.

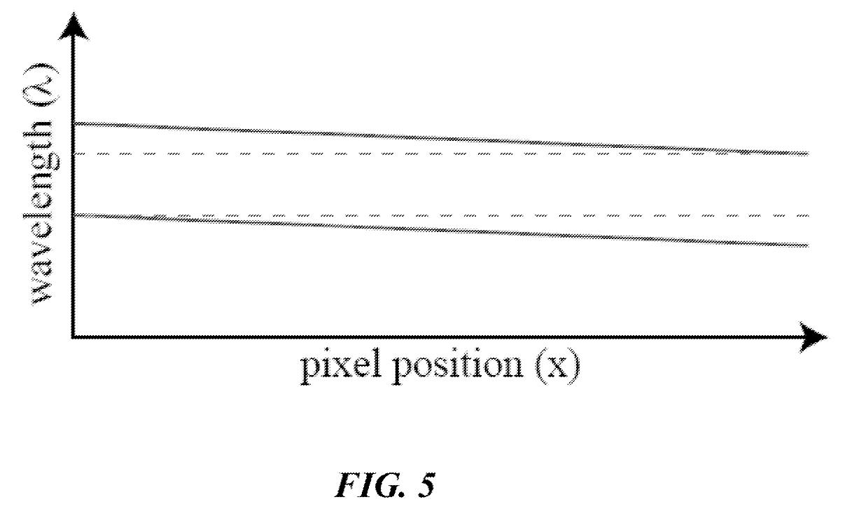

The image formed at the plane S remains in perfect, focus irrespective of the aperture size. A tradeoff exists between the aperture size or the amount of light and the desired spectral selectivity in the R-plane. With a large aperture size, the selected wavelength (vertical axis) varies with pixel position (horizontal axis) in an image at the sensor 110 as shown in FIG. 5.

In the case of the camera application of FIG. 1B, we acquire a multi-spectral dataset by capturing multiple images with different positions of the slits of the mask at the R-plane. Each slit position allows a small subset of wavelengths to pass through, thus blocking a large portion of the light. A better signal to noise ratio can be achieved by using a Hadamard coded masks instead of a single slit. The multiple images can then be combined in numerous manners to obtain various agile spectrum output images, in real time for various visual effects.

Closely related to the camera setup of FIG. 1B is a direct view device as shown in FIG. 1C. With this device, a user views a scene and mechanically modifies its color spectrum by moving the mask. This offers arbitrary wavelength modulation and is more powerful than a liquid-crystal tunable filter (LCTF) or an acousto-optical tunable filter (AOTF), which usually only allow a single wavelength to pass through. In this way, our apparatus can be used as camera viewfinder. If implemented as a small hand-held device, the apparatus can be used in applications such as metamer detection, and help users with color blindness.

So far we have described the optical design for a agile spectrum camera. The same design also works just as well for a projector as shown in FIG. 1D. In this case, the first lens L₁ corresponds to the projection lens of what otherwise be a conventional projector. We focus the projected image onto the diffraction grating, and place the screen in the S plane as described above.

Projectors usually have a long folded optical path. Therefore, the condition of Equation 5 are actually easier to achieve than in the case of the camera. The agile spectrum projector is also useful as a controllable spectrum light source as shown in FIG. 1D. In this case, the projector projects white light that covers the scene, the mask is manipulated to achieve any desired spectral effect in the scene.

A number of interesting applications and are enabled by our agile spectrum apparatus.

Spectrally Controllable Light Source

A spectrally controllable light source, as in FIG. 1D, enables a user to view a scene or object in different colored illumination by simply sliding a mechanical mask or modulating an LCD in the R-plane. This allows one to easily discern metamers in the scene. Metamers are colors that look very similar to the human eye (or a camera), but actually have very different spectrums. This happens because the cone cells of the eye, or the Bayer filters on a camera sensor, have a relatively broad spectral response, sometimes resulting in significantly different spectrums having the exact same R,G,B value as sensed by the eye or recorded by the camera.

For example, the scene includes a plant with green leaves and a red flower. If the scene is illuminated with white light, then, for a person with a type of color blindness called Deuteranope, the red and green hues appear very similar. We can change the color of the illumination by selectively blocking green wavelengths making the leaves dark and clearly different from the red flower.

Spectral High Dynamic Range Photography and Glare Removal

The agile spectrum camera of FIG. 1B can be used to acquire high dynamic range (HDR) images. Instead of using spatially varying exposures, we can use spectrally varying exposures by modulating the colors in the R-plane appropriately. For example, a scene includes a very bright green light source aimed at the camera, e.g., a green LED. In an image acquired of the scene by a conventional camera, the LED is too bright. Not only is the image saturated, the light also causes glare that renders part of scene indiscernible. Reducing the exposure does not help because it makes the rest of the scene too dark. Instead, we block the green wavelength by using an appropriate mask in the R-plane. Thus, the red light component in the scene is unaffected, and the intensity of the LED and the glare is greatly reduced.

Unlike spatial attenuation as used for conventional HDR, the green color is attenuated uniformly throughout the image. As a result, the color of the scene turns pinkish. This does remove the glare almost completely so that the image has much more detail than before.

Unlike conventional approaches for glare reduction, we do not change anything outside the camera. Once we know the color of the offending highlight, we require only a single image. Also, because the wavelength modulation can be arbitrary, we can easily remove multiple glares of different colors, something not possible using a conventional colored filters. A closed-loop spectral HDR capture system can be useful for complex scenes where conventional techniques fail to capture all the detail.

Improved Color Rendition

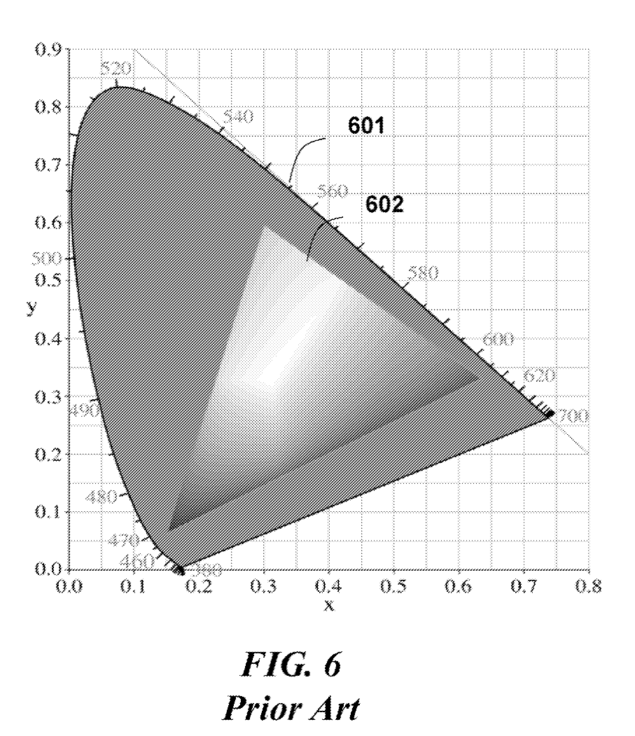

Most display devices have a very limited color space compared to the gamut defined by the CIE-xy color space chromaticity diagram, see FIG. 6. In particular, most devices are extremely limited in the blue-green region on the left and top of the gamut 601. Reproducing a pure cyan color is considered challenging for any RGB based projector/camera. Specifically, the cyan color can appear to “leak,” suggesting the projected cyan is indeed a mixture of green and blue, and not a pure color. With our agile spectrum projector, the cyan can be made to appear very different from colors obtained by mixing blue and green. In fact, it is a saturated, pure cyan that is not possible to obtain by simply conventionally mixing blue and green.

Adaptive Color Primaries

Conventional cameras and projectors use standard RGB color primaries. These color primaries are chosen to match the response of the cone cells in the eye. They work reasonably well for some scenes, but cause serious artifacts like metamers and loss of contrast in others. Recently, projector manufacturers have started experimenting with six or more color primaries to get better color reproduction.

Instead, we can adapt the color primaries to a projected or acquired scene. We can use an LCD, and digital micro devices (DMD) in place of the mask 104.

If the LCD is synchronized to the spatial projection DMD, we can in fact remove the color wheel in the projector, and simulate an arbitrary color wheel using wavelength modulation. Arbitrary adaptive color primaries result in better color rendition, fewer metamers, brighter images, and enhanced contrast.

A conventional RGB projector projects the red component of the image for one third of the time, blue a second third, and green the last third of the time.

Consider a yellow pixel in a traditional projector. This pixel is turned “on” when the red and green filters are placed in the optical path. Assuming each of the red, green, and blue filters allow a third of the visible light through, the intensity of a yellow pixel is

$$\frac{1}{3} \times \frac{1}{3} + \frac{1}{3} \times \frac{1}{3} + \frac{1}{3} \times 0 = \frac{2}{9}$$

the light intensity. A blue pixel is only 1/9 the light intensity. With adaptive primaries, we need only two colors, and each can be displayed for half the time. The blue pixel intensity increases to ⅙, and the yellow pixel to ⅓ the light intensity. We also have the added flexibility of making the yellow color more saturated by narrowing the corresponding filter at the expense of reduced light.

In our agile spectrum apparatus, the aperture of the objective lens is much smaller than the distance to the diffraction grating, Equation 5. A large aperture may result in undesirable spatially varying wavelength blur at the sensor plane. However, we get reasonable wavelength resolution with a finite sized aperture f/16 or smaller. In most applications this limitations is not a serious problem.

Like a conventional projector, our agile spectrum projector produces an in-focus image in a particular plane. But unlike the conventional projector, any other plane can have chromatic artifacts in addition to the usual spatial blur. This is not a problem in the camera case because the position of the grating, lens L₂ and the sensor is fixed, and the sensor and the grating are always conjugate to one another. A point that is outside the plane of focus of the objective lens L₁ behaves as expected. The point is de-focused on the sensor without any chromatic artifacts, and the mask in the R-plane modulates its color just like an in-focus point.

Most modern digital cameras include memories and microprocessors or microcontroller. Likewise our camera can include a controller 108, which provides control over attenuating wavelength as in conventional multi-spectral cameras, monochromators, and other traditional narrow-band spectrographic instruments.

In a DLP projector according to our design, the color wheel is replaced with a fast LCD to select the color. Color calibration can take into account the non-linear nature of the diffraction gratings and the bent optical axis.

### EFFECT OF THE INVENTION

The invention provides an agile spectrum imaging apparatus and method to provide high-resolution control of light spectra at every stage of computational photography. A simple optical relay permits direct wavelength manipulation by geometrically-patterned gray-scale masks. The design applies 4D ray-space analysis to dispersed elements within a multi-element lens system, rather than conventional filtering of 2D images by selective optical absorption.

Spectrum control does not require wavelength-selective filter materials. As far as we know, this is the only configuration to control wavelength spectrum using a purely mechanical mask for a perspective device with non-pin-hole aperture and with no-light loss.

Our analysis determines the ideal “rainbow plane” mask where rays converge so that wavelength determines ray location x, and image position (x, y) determines ray direction q. While 4D ray models of conventional 2D imaging show x and θ convergence at the image sensor, and lens aperture respectively, the converged wavelengths of the “rainbow plane” map wavelength to position. Away from this plane, the optical relay provides a graceful tradeoff between wavelength selectivity and the entrance aperture size.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. An apparatus for agile spectrum imaging comprising:
a first lens;
means for dispersing light over a spectrum of wavelengths;
a second lens; and
a mask, all arranged in an order on an optical axis between a light source and a light destination, in which the mask selectively attenuates the wavelengths of the spectrum of the light source onto an image plane of the light destination.

2. The apparatus of claim 1, in which the light source is a scene and the light destination is sensor, and the apparatus operates as an agile spectrum camera.

3. The apparatus of claim 1, in which the light source is a scene and the light destination is an eye, and the apparatus operates as an agile spectrum viewer.

4. The apparatus of claim 1, in which the light source is a projector and the light destination is a display screen, and the apparatus operates as an agile spectrum projector.

5. The apparatus of claim 1, in which the light source is a projector, and the light destination is a scene, and the apparatus operates as a agile spectrum light source.

6. The apparatus of claim 1, further comprising:
a first agile spectrum projector in which the light source is a first projector;
a second agile spectrum projector in which the light source is a second projector, in which the first and second agile spectrum projectors project images onto a display screen;
a first agile spectrum viewer in which the light source is the display screen and the light destination is a first eye of a human visual system; and
a second agile spectrum viewer in which the light source is the display screen and the light destination is a second eye of the human visual system, and in which the first and second agile spectrum projectors and the first and second agile spectrum viewers have complementary non-overlapping spectrum profiles, such that each has a band in a spectral wavelengths matching red, green and blue hues of the human visual system.

7. The apparatus of claim 1, in which the means for dispersing is a transmissive or reflective diffraction grating.

8. The apparatus of claim 1, in which the means for dispersing is a prism.

9. The apparatus of claim 1, in which the mask is movable a plane tangential to the optical axis by a stepper motor.

10. The apparatus of claim 1, in which the mask is a grayscale mask printed on transparencies.

11. The apparatus of claim 1, in which the in ask is a liquid crystal display.

12. The apparatus of claim 1, in which the mask uses digital micro devices.

13. The apparatus of claim 1, in which the first lens is a pinhole.

14. The apparatus of claim 1, in which the first lens is a finite aperture lens.

15. The apparatus of claim 1, in which the optical axis is bent and the second lens and mask are at an angle with respect to the diffraction grating.

16. The apparatus of claim 1, in which the mask passes only a selected arbitrary color.

17. The apparatus of claim 1, in which the first lens has a relatively large focal length and a relatively small aperture.

18. The apparatus of claim 17, in the relatively large focal length is 80 mm, and the relatively small aperture is f/16.

19. The apparatus of claim 2, in which the camera acquires multiple images with different positions of the mask, and the multiple images are combined in numerous to obtain agile spectrum output images.

20. The apparatus of claim 3, in which the viewer is a hand-held device for metamer detection.

21. The apparatus of claim 2, in which the camera acquires high dynamic range images using spectrally varying exposures.

22. The apparatus of claim 2, in which the scene includes a bright light source and the camera removes glare by modulating the colors at a plane of the mask.

23. The apparatus of claim 1, in which an aperture of the objective is much smaller than a distance to the means for diffracting.

24. The apparatus of claim 1, further comprising:
a stepper motor configure to move the mask to select arbitrary colors.

25. A method for agile spectrum imaging comprising the steps of:
first focusing light from a light source on means for dispersing;
dispersing the focused light over a spectrum of wavelengths;
second focusing the dispersed light onto a color selective mask; and
attenuating selectively the focused dispersed light onto an image plane of a light destination.
